(19) United States
(12) Patent Application Publication
(10) Pub. No.: US 2018/0297698 A1
(43) Pub. Date: Oct. 18, 2018

(54) Aircraft Having Telescopic Wings and Tilting Motor Assemblies

(71) Applicant: Sanjay Dhall, Canton, MI (US)

(72) Inventor: Sanjay Dhall, Canton, MI (US)

(21) Appl. No.: 15/486,981

(22) Filed: Apr. 13, 2017

(51) Int. Cl. B64C 29/00; B64C 3/56; B64C 37/00; B64C 11/28

(52) U.S. Cl. CPC B64C 29/0033; B64C 11/28; B64C 37/00; B64C 3/56

(57) ABSTRACT

An aircraft includes a fuselage and a storage bay formed in the fuselage. A wing has an outboard end, has an inboard end, is moveable relative to the fuselage in an outboard direction to an extended position, and is moveable relative to the fuselage in an inboard direction into the storage bay to a retracted position. A motor assembly is located at the outboard end of the wing and is pivotally connected to the wing. The motor assembly includes a propeller and a motor operable to rotate the propeller.

### BACKGROUND

Designs have been previously proposed for reducing the space occupied by aircraft wings when the aircraft is not in flight. These designs have been proposed both for conventional fixed-wing aircraft as well as roadable aircraft. Generally stated, roadable aircraft are aircraft that may be converted for surface travel upon a roadway. Telescopic wing designs have previously proposed for reducing the space occupied by the wings of an aircraft when it is not in flight. In telescopic wing designs, at least one portion of the wing retracts longitudinally into an adjacent portion of the wing.

### SUMMARY

One aspect of the disclosed embodiments is an aircraft that includes a fuselage and a storage bay formed in the fuselage. A wing has an outboard end, has an inboard end, is moveable relative to the fuselage in an outboard direction to an extended position, and is moveable relative to the fuselage in an inboard direction into the storage bay to a retracted position. A motor assembly is located at the outboard end of the wing and is pivotally connected to the wing. The motor assembly includes a propeller and a motor operable to rotate the propeller.

In some implementations, the storage bay includes a wing storage area and a motor storage area, and at least part of the motor is disposed in the motor storage areas of the storage bay when the wing is in the retracted position.

In some implementations, the propeller includes propeller blades and a propeller hub, wherein the propeller blades are pivotally connected to the propeller hub for movement between deployed positions and stowed positions. In some implementations, the motor assembly includes a motor housing. In some implementations, the propeller blades extend along the motor housing in the stowed position.

In some implementations, the motor storage area is defined in part by wall portions and the propeller blades are located between the motor housing of the motor assembly and the wall portions of the motor storage area when the propeller blades are in the stowed positions and the wing is in the retracted position.

In some implementations, the aircraft includes one or more closure panels that are connected to the fuselage adjacent to an opening defined in the fuselage by the storage bay, wherein the closure panels are moveable with respect to the fuselage between an open position when the wing is in the extended position to allow the wing to extend out of the opening, and a closed position when the wing is in the retracted position to protect the motor assembly. In some implementations, the one or more closure panels include an upper closure panel and a lower closure panel, wherein the upper closure panel is connected to the fuselage above the opening and extends downward, and the lower closure panel is connected to the fuselage below the opening and extends upward.

In some implementations, a closure panel is connected to the motor housing of the motor assembly and obstructs at least part of an opening defined in the fuselage by the storage bay when the wing is in the retracted position. In some implementations, at least part of the closure panel extends upward from the motor housing to the fuselage when the wing is in the retracted position, and at least part of the closure panel extends downward from the motor housing to the fuselage when the wing is in the retracted position. In some implementations, the propeller blades are located inboard relative to the closure panel when the wing is in the retracted position.

In some implementations, the motor assembly is pivotable with respect to the wing to a tractor position. In some implementations, the motor assembly is pivotable with respect to the wing to a pusher position. In some implementations, the motor assembly is pivotable with respect to the wing to a vertical flight position.

In some implementations, the aircraft includes a pivot joint that pivotally connects the motor assembly to the wing. In some implementations, the aircraft includes a pivot actuator for pivoting the motor assembly with respect to the wing.

In some implementations, the wing has two or more telescopically-related sections.

### BRIEF DESCRIPTION OF THE DRAWINGS

The description herein makes reference to the accompanying drawings wherein like numerals refer to like parts throughout several views and wherein:

FIG. 1A is a top view of a first aircraft in a vertical flight configuration.

FIG. 1B is a perspective view of the first aircraft in the vertical flight configuration.

FIG. 1C is a front view of the first aircraft in the vertical flight configuration.

FIG. 2A is a top view of the first aircraft in a horizontal flight configuration.

FIG. 2B is a perspective view of the first aircraft in the horizontal flight configuration.

FIG. 2C is a front view of the first aircraft in the horizontal flight configuration.

FIG. 3A is a top view of the first aircraft in a wings-stowed configuration.

FIG. 3B is a perspective view of the first aircraft in the wings-stowed configuration.

FIG. 3C is a front view of the first aircraft in the wings-stowed configuration.

FIG. 4A is a top view of a second aircraft in a vertical flight configuration.

FIG. 4B is a perspective view of the second aircraft in the vertical flight configuration.

FIG. 4C is a front view of the second aircraft in the vertical flight configuration.

FIG. 5A is a top view of a third aircraft in a vertical flight configuration.

FIG. 5B is a perspective view of the third aircraft in the vertical flight configuration.

FIG. 5C is a front view of the third aircraft in the vertical flight configuration.

FIG. 6A is a side view of a motor assembly with propeller blades in extended positions.

FIG. 6B is a side view of the motor assembly with propeller blades in stowed positions.

FIG. 7A is a perspective view of a wing in an extended position with the motor assembly in a tractor position.

FIG. 7B is a perspective view of the wing in an extended position with the motor assembly in a pusher position.

FIG. 7C is a perspective view of the wing in an extended position with the motor assembly in vertical flight position.

FIG. 7D is a perspective view of the wing in the retracted position.

FIG. 8 is an illustration of a wing that is retracted into a storage bay, according to a first example.

FIG. 9 is an illustration of a wing that is retracted into a storage bay, according to a second example.

FIG. 10 is an illustration of a wing that is retracted into a storage bay, according to a third example.

FIG. 11 is a perspective view of a wing and a motor assembly having forward and rearward propellers.

FIG. 12 is a perspective view of a wing, a forward motor assembly and a rearward motor assembly.

### DETAILED DESCRIPTION

The description herein relates to aircraft having wings that telescopically extend and retract, with tilting motor assemblies located at the outboard ends of the wings to allow horizontal and vertical flight modes.

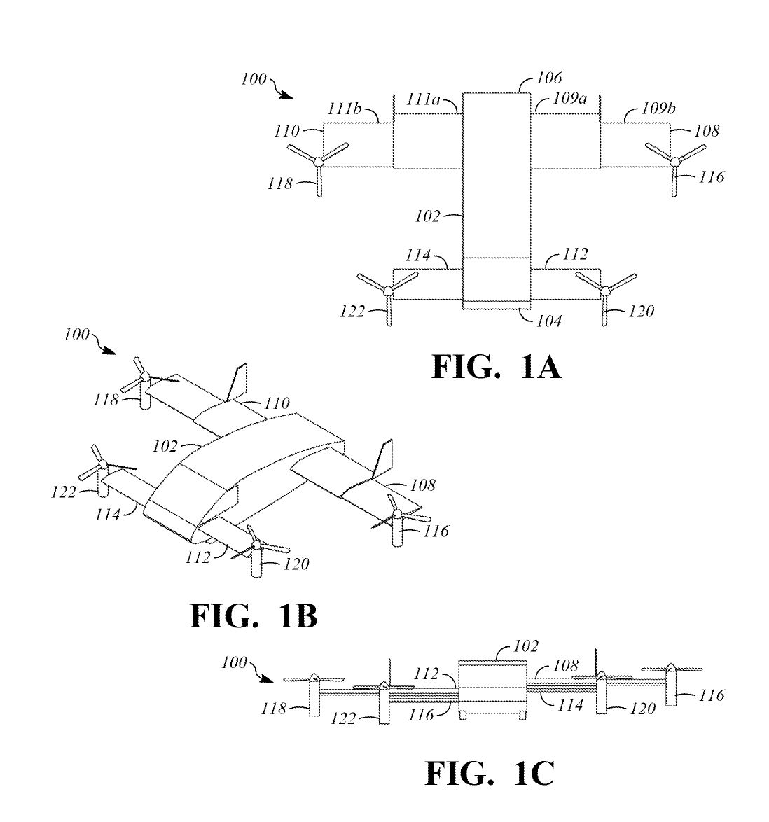

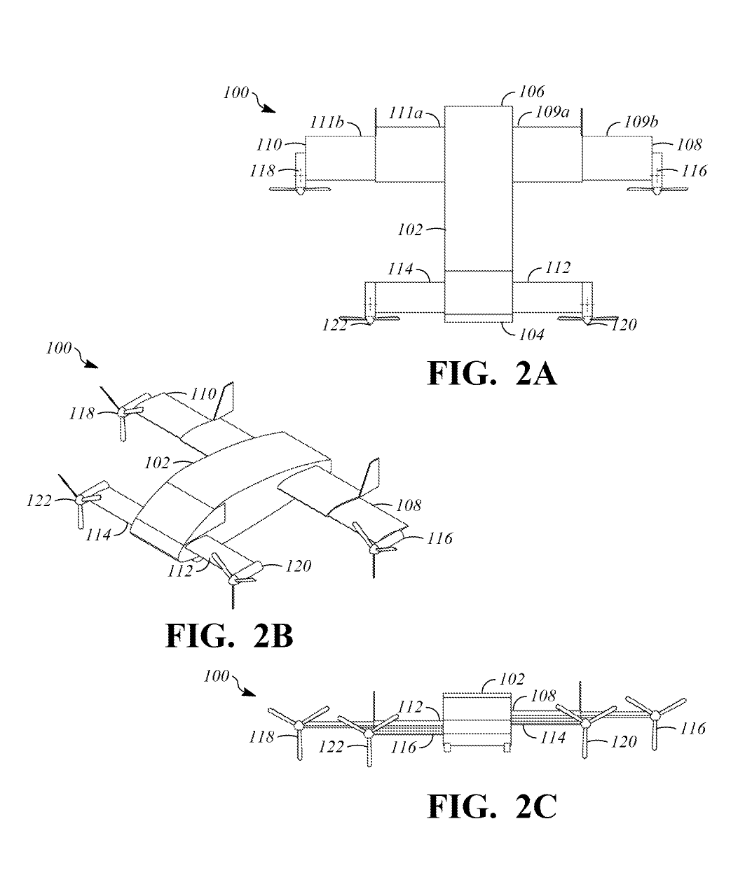

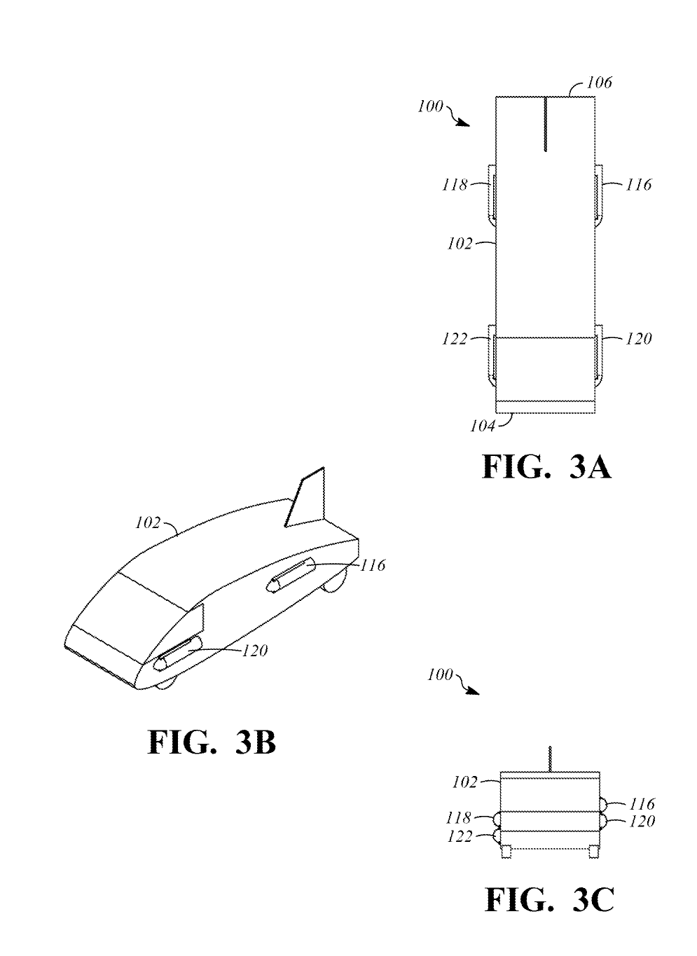

FIGS. 1A-1C, FIGS. 2A-2C, and FIGS. 3A-3C show a first aircraft 100. The first aircraft 100 is convertible between a vertical flight configuration (FIGS. 1A-1C), a horizontal flight configuration (FIGS. 2A-2C), and a wings-stowed configuration (FIGS. 3A-3C). The vertical flight configuration is intended for use during vertical takeoff and landing operations in which the first aircraft 100 remains airborne by virtue of thrust generating components (e.g., propellers, rotors, or jet engines). The horizontal flight configuration is intended for use during flight of the first aircraft 100 in which forward motion of the first aircraft 100 allows lift-generating components (e.g., wings) to keep the aircraft aloft. The wings-stowed configuration is intended for use when the first aircraft 100 is on the ground, which allows the first aircraft 100 to be stored in a small space or to be utilized as a road-going vehicle (i.e., a roadable aircraft).

The first aircraft 100 has a fuselage 102 that extends from a nose end 104 to a tail end 106. The direction extending generally from the nose end 104 to the tail end 106 of the first aircraft 100 is referred to herein as the longitudinal direction of the first aircraft 100.

The first aircraft 100 includes a left primary wing 108, a right primary wing 110, a left secondary wing 112, and a right secondary wing 114. Each of the left primary wing 108, the right primary wing 110, the left secondary wing 112, and the right secondary wing 114 include lift generating surfaces that produce lift during horizontal flight, and each can also include control surfaces that can be manipulated to control pitch, roll, and yaw of the first aircraft 100. The left primary wing 108, the right primary wing 110, the left secondary wing 112, and the right secondary wing 114 can be retracted into the fuselage 102 to define the wings-stowed configuration (FIGS. 3A-3C).

The designations “primary” and “secondary” as used herein are intended to allow the reader to distinguish between the two wings. While the wings may differ in size and amount of lift provided, these designations are not intended to imply such differences. Thus, for example, the left primary wing 108 and the right primary wing 110 could have a greater combined lift generating area than the combined lift generating area of the left secondary wing 112 and the right secondary wing 114, or could have a smaller combined lift generating area than the left secondary wing 112 and the right secondary wing 112. In some implementations, the extended lengths of the left primary wing 108 and the right primary wing 110 are longer than the extended lengths of the left secondary wing 112 and the right secondary wing 114. In some implementations, the extended lengths of the left primary wing 108 and the right primary wing 110 are shorter than the extended lengths of the left secondary wing 112 and the right secondary wing 114. In some implementations, the extended lengths of the left primary wing 108 and the right primary wing 110 are equal to the extended lengths of the left secondary wing 112 and the right secondary wing 114.

The left primary wing 108 includes an inner section 109a and an outer section 109b. The outer section 109b is telescopically related to the inner section 109a and can be retracted into the inner section 109a. The inner section 109a is telescopically related to the fuselage 102. This allows the left primary wing 108 to be retracted into the fuselage 102, including the inner section 109a and the outer section 109b.

The right primary wing 110 includes an inner section 111a and an outer section 111b. The outer section 111b is telescopically related to the inner section 111a and can be retracted into the inner section 111a. The inner section 111a is telescopically related to the fuselage 102. This allows the right primary wing 110 to be retracted into the fuselage 102, including the inner section 111a and the outer section 111b.

The left primary wing 108 and the right primary wing 110 are vertically offset from one another. As an example, a bottom surface of the left primary wing 108 can be positioned higher relative to the fuselage 102 than a top surface of the right primary wing 110. This allows the left primary wing 108 and the right primary wing 110 to be disposed in the fuselage 102, when retracted, in a vertically stacked configuration, without mechanical interference that would result if they were aligned vertically. The vertically stacked configuration for the left primary wing 108 and the right primary wing 110 allows for more compact storage within the fuselage 102 in the retracted position.

The left secondary wing 112 and the right secondary wing 114 are each telescopically related to the fuselage 102 and can be retracted into the fuselage 102. The left secondary wing 112 and the right secondary wing are vertically offset, as described with respect to the left primary wing 108 and the right primary wing 110.

The first aircraft 100 includes a first motor assembly 116, a second motor assembly 118, a third motor assembly 120, and a fourth motor assembly 122, each being connected to the outer end of one of the left primary wing 108, the right primary wing 110, the left secondary wing 112, and the right secondary wing 114, and each supported in a manner that allows pivoting relative to the wings to move between the vertical flight configuration (FIGS. 1A-1C) and the horizontal flight configuration (FIGS. 2A-2C). In the vertical flight configuration, the motor assemblies 116, 118, 120, 122 are oriented in a generally vertical direction that allows most of the thrust to be directed in the vertical direction as opposed to the horizontal direction. In the horizontal flight configuration, the motor assemblies 116, 118, 120, 122 are oriented in a generally horizontal configuration direction that allows most of the thrust to be directed in the horizontal direction as opposed to the vertical direction.

The first aircraft 100 may also include components that allow road-going use, such as wheels, a propulsion system operable to drive the wheels, a steering system, and a braking system.

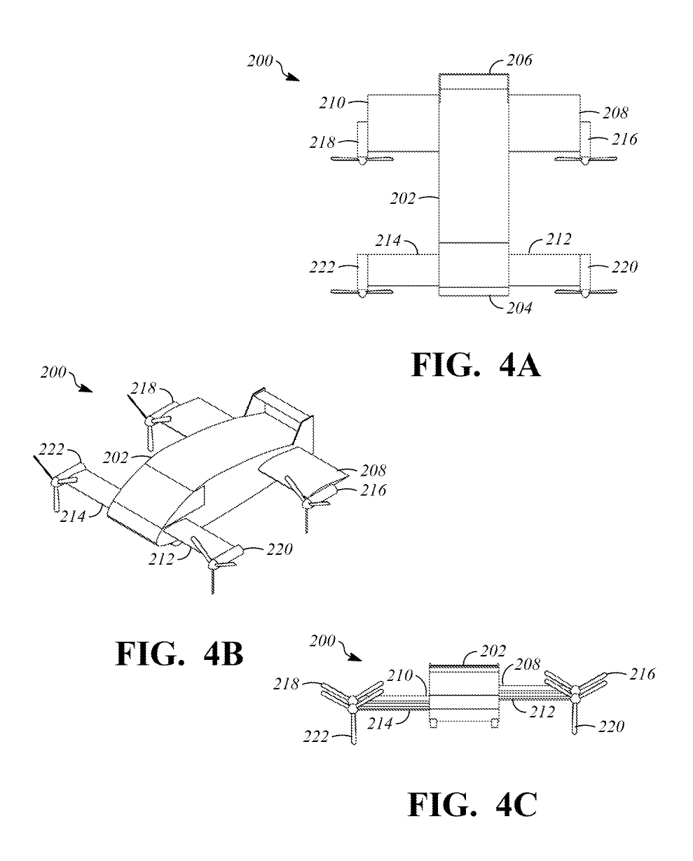

FIGS. 4A-4C show a second aircraft 200. The second aircraft 200 is convertible between a vertical flight configuration (FIGS. 4A-4C), a horizontal flight configuration, and a wings-stowed configuration. The second aircraft 200 is similar to the first aircraft 100 except as described herein.

The second aircraft 200 has a fuselage 202 with a nose end 204 and a tail end 206. The lift generating components of the second aircraft 200 include a left primary wing 208, a right primary wing 210, a left secondary wing 212, and a right secondary wing 214, each of which has a single section that is telescopically related to the fuselage 202 for motion between extended and retracted positions. The extended lengths of the left primary wing 208 and the right primary wing 210 are longer than the extended lengths of the left secondary wing 212 and the right secondary wing 214.

The second aircraft 200 includes a first motor assembly 216, a second motor assembly 218, a third motor assembly 220, and a fourth motor assembly 222, each being connected to the outer end of one of the left primary wing 208, the right primary wing 210, the left secondary wing 212, and the right secondary wing 214, and each supported in a manner that allows pivoting relative to the wings to move between the vertical flight and the horizontal flight configuration.

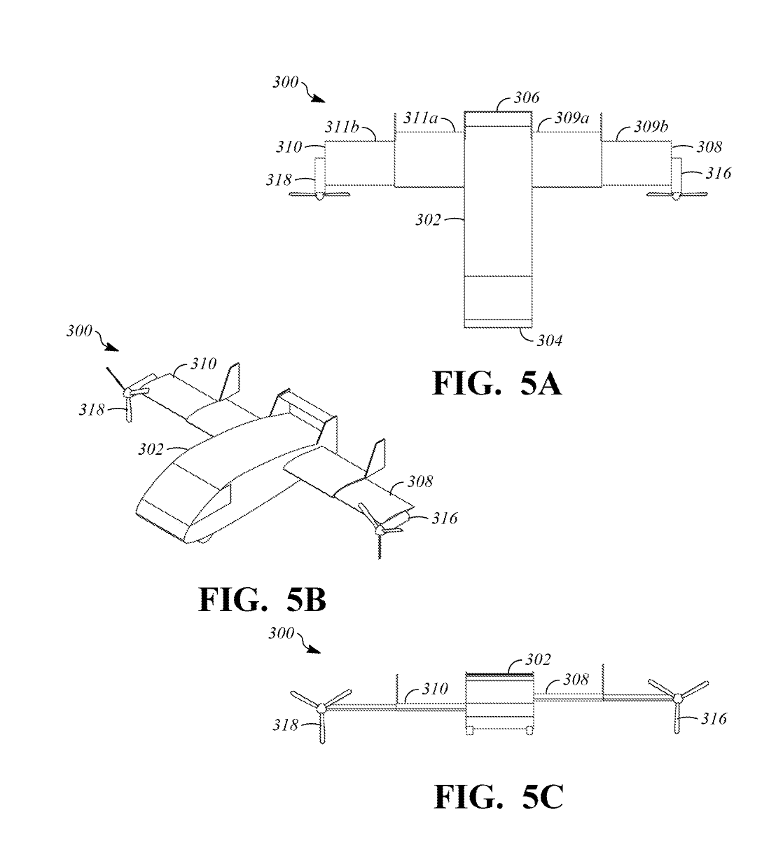

FIGS. 5A-5C show a third aircraft 300. The third aircraft 300 is convertible between a vertical flight configuration, a horizontal flight configuration, and a wings-stowed configuration. The third aircraft 300 is similar to the first aircraft 100 except as described herein.

The third aircraft 300 has a fuselage 302 with a nose end 304 and a tail end 306. The lift generating components of the third aircraft 300 include a left primary wing 308 and a right primary wing 310. The left primary wing 308 includes an inner section 309a and an outer section 309b that are telescopically related for retraction into the fuselage 302 in the manner described with respect to the third aircraft 300. The right primary wing 310 includes an inner section 311a and an outer section 311b that are telescopically related for retraction into the fuselage 302 in the manner described with respect to the third aircraft 300.

The third aircraft 300 includes a first motor assembly 316 and a second motor assembly 318, each being connected to the outer end of one of the left primary wing 308 and the right primary wing 310, and each supported in a manner that allows pivoting relative to the wings to move between the vertical flight and the horizontal flight configuration.

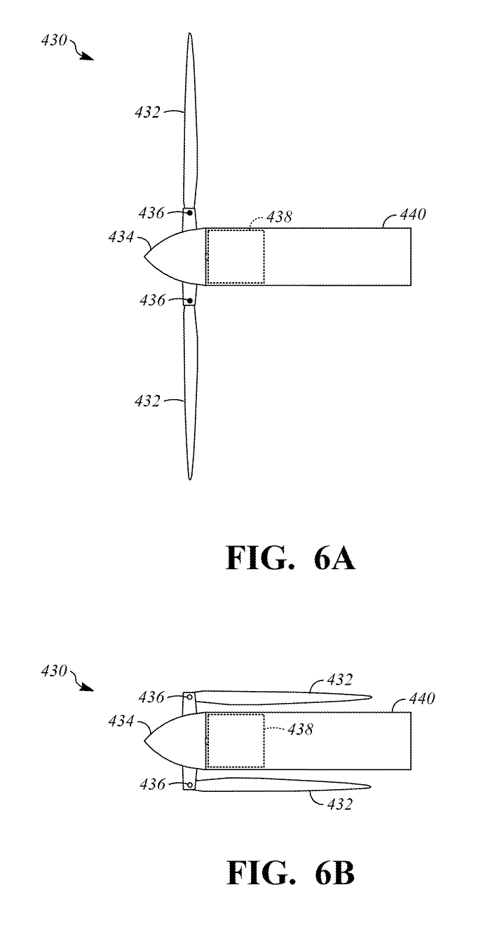

FIGS. 6A-6B show a motor assembly 430 that has a propeller including propeller blades 432 and a propeller hub 434. FIG. 6A is a side view of the motor assembly 430 with the propeller blades 432 in deployed positions, and FIG. 6B is a side view of the motor assembly 430 with the propeller blades 432 in stowed positions. The propeller blades 432 are each connected to the propeller hub 434 by a pivot joint 436. Each of the propeller blades 432 is moveable between the deployed position (extending generally outward from an axis of rotation) and the stowed position (extending generally parallel to the axis of rotation) by rotating at the respective one of the pivot joints 436. The pivot joints 436 can include locking features to restrain unintended motion of the propeller blades 432. The propeller blades 432 can be moved between the extended and stowed positions manually, by using an actuator (not shown).

The motor assembly 430 includes a motor 438 that is located in a motor housing 440. The propeller hub 434 is rotated by the motor 438 to cause rotation of the propeller blades 432. The motor 438 can be an internal combustion engine or an electric motor.

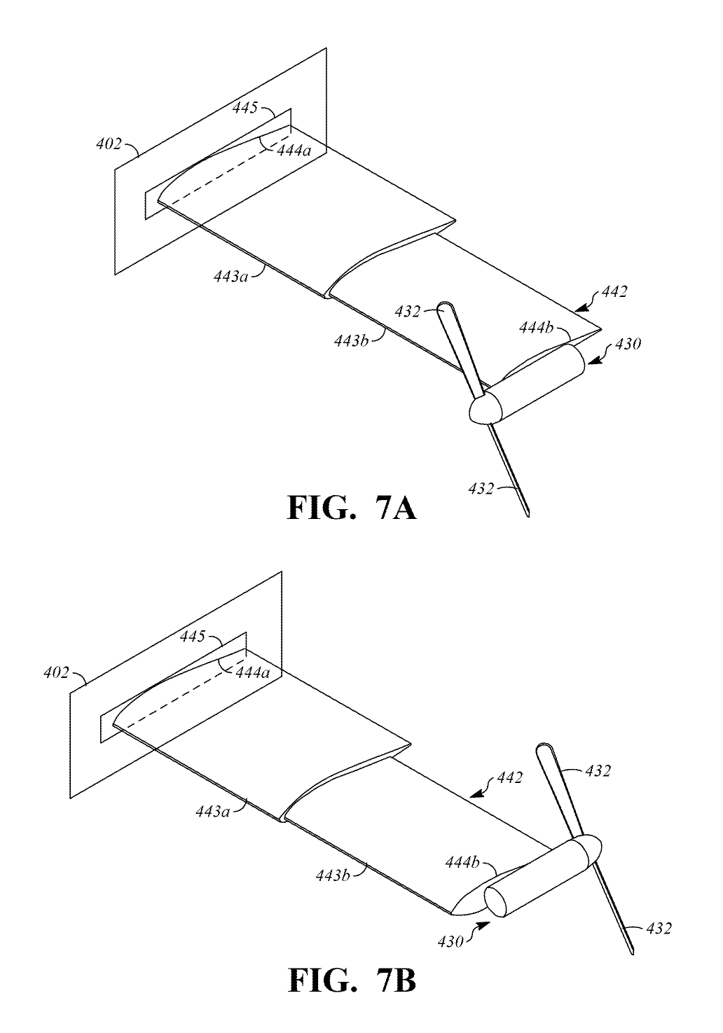

FIGS. 7A-7D are perspective views showing a wing 442 that includes the motor assembly 430. The wing 442 is connected to a fuselage 402 as described with respect to the first aircraft 100, the second aircraft 200, and the third aircraft 300. The wing 442 includes an inner section 443a and an outer section 443b. The outer section 443b is telescopically related to the inner section 443a and the outer section 443b is able to retract into the inner section 443a. The inner section 443a is telescopically related to the fuselage 402 and is able to retract into the fuselage 402 through an opening 445 that is formed in the fuselage 402. An inner end 444a of the wing 442 is connected to the fuselage 402, and the motor assembly 430 is connected to an outer end 444b of the wing 442.

As will be explained further herein, the motor assembly 430 is connected to the outer end 444b of the wing 442 in a manner that allows rotation of the motor assembly 430 on an axis that extends generally in the direction of the wing 442 between the inner end 444a and the outer end 444b of the wing 442. This results in the wing 442 rotating generally within a plane that lies transverse to the wing 442.

Rotation of the motor assembly 430 allows for several flight configurations. In FIG. 7A, the wing 442 is in the extended position with the motor assembly 430 in a tractor position. In the tractor position, the propeller blades 432 are positioned forward of the wing 442 and can be operated to generate thrust in the rearward direction to allow for horizontal flight. In FIG. 7B, the wing 442 is in the extended position with the motor assembly 430 in a pusher position. In the pusher position, the propeller blades 432 are located rearward of the wing 442 and can be operated to generate thrust in the rearward direction to allow for horizontal flight. In FIG. 7C, the wing 442 is in the extended position with the motor assembly 430 is a vertical flight position. In the vertical flight position, the propeller blades 432 are located above the wing 442 are can be operated to generate thrust in a downward direction to allow for vertical flight, such as during vertical takeoff and landing operations.

FIG. 7D is a perspective view showing the wing 442 in the retracted position. The motor assembly 430 is in the tractor position, with the propeller blades 432 in the stowed position, as described with respect to FIGS. 6A-6B. The outer section 443b is retracted into the inner section 443a, and the inner section 443a is retracted into the fuselage 402. When retracted, the wing 442 can be disposed in a storage bay 446 that is formed in the fuselage 402. The storage bay 446 can include features that support and stabilize the wing 442 while it is disposed in the fuselage 402. When the wing 442 is the in the retracted position, the motor assembly 430 can be disposed partially or fully in the fuselage 402, as will be explained herein.

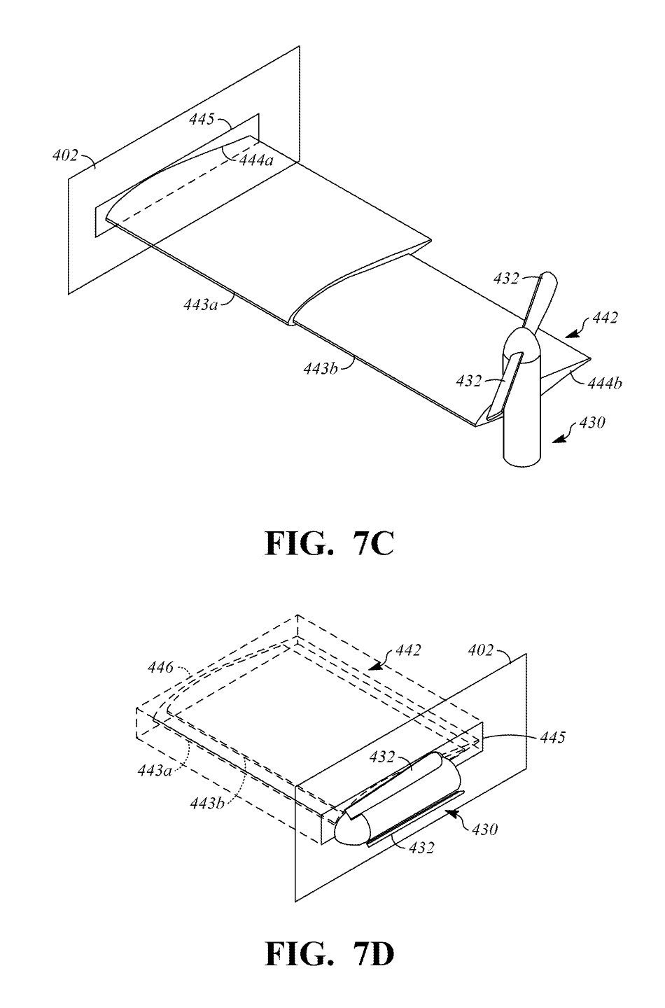

FIG. 8 is a cross-section view showing a wing 542. The wing 542 and other features shown in FIG. 8 are the same as features described with respect to FIGS. 7A-7D, except as described herein.

The wing 542 includes one or more telescopically-related portions, such as an inner section 543a and an outer section 543b, which are shown in the retracted position. A motor assembly 530 is connected to an outer end 544b of the wing 542 by a pivot joint 556 and a pivot actuator 558. The pivot joint 556 extends from the fuselage 502 to the motor assembly 530, and connects the motor 530 to the outer section 543b of the wing 542 in a manner that allows pivoting of the motor assembly 530 with respect to the wing 542. The pivot actuator 558 is operable to cause rotation of the motor assembly 530 at the pivot joint 556. The pivot actuator 558 can be located in the outer section 543b of the wing 542, or the pivot actuator 558 can be located in the motor housing 540 of the motor assembly 530, as depicted in FIG. 8. As an example, the pivot actuator 558 can be connected to an external control system that controls operation of the pivot actuator 558, such as by transmitting control signals that are received by the pivot actuator 558.

As described with respect to previous examples, the motor assembly 530 can be pivoted using the pivot joint 556 and the pivot actuator 558 to define several configurations. The motor assembly 530 is depicted in the tractor configuration in FIG. 8, and propellers 532 that are included in the motor assembly 530 are in their stowed positions, extending along and closely adjacent to an exterior surface of a motor housing 540 of the motor assembly 530, with one of the propellers 532 being located directly above the motor housing 540 and the other one of the propellers 532 being located directly below the motor housing 540 of the motor assembly 530. The propellers 532 are moved to their stowed positions using pivot joints (not shown in FIG. 8), in the manner described with respect to FIGS. 6A-6B. The configurations for the motor assembly 530 relative to the wing 542 are as previously described, including the tractor configuration, the pusher configuration, and the vertical flight configuration.

In the retracted position, the wing 542 is located in the storage bay 546. The storage bay 546 is formed in a fuselage 502 of the aircraft, which can be, as examples, the first aircraft 100, the second aircraft 200, or the third aircraft 300. The storage bay 546 has a wing storage area 547a defined in part by an upper structure 548 and a lower structure 550. The upper structure 548 and the lower structure 550 can each include one or more or wall portions, beams, frames, or other structures define the wing storage area 547a to provide a space in which the wing 542 can be received. In the retracted position, the wing 542 is located below the upper structure 548 and is located above the lower structure 550. Stabilizing features (not shown), such as slides, rollers, or support structures can be located in the wing storage area 547a of the storage bay 546 to restrain motion of the wing 542 with respect to the storage bay 546.

The wing storage area 547a may have and internal shape that is defined by the upper structure corresponds to the shape of the wing 542. The wing storage area 547a may have a maximum internal height defined by a largest spacing between the upper structure 548 and the lower structure 550.

The storage bay 546 meets an outer surface 503 of the fuselage 502 at an opening 545 of the storage bay 546. A motor storage area 547b is located near the opening 545, and allows at least partial retraction of the motor assembly 530 into the fuselage 502 in order to protect the motor assembly 530 including the propellers 532. The motor storage area 547b is located inboard from the outer surface 503 of the fuselage 502, and is defined by an upper wall portion 552 and a lower wall portion 554. The upper wall portion 552 extends from the outer surface 503 of the fuselage 502 to the upper structure 548 of the wing storage area 547a. The lower wall portion 554 extends from the outer surface 503 of the fuselage 502 to the lower structure 550 of the wing storage area 547a. The shape of each of the upper wall portion 552 and the lower wall portion 554 is complementary to the shape of the motor housing 540 and the propellers 532, so that at least portions of the motor housing 540 and the propellers 532 are positioned closely adjacent to the upper wall portion 552 and the lower wall portion 554. As an example, at least part of the upper wall portion 552 can be positioned directly above one the propellers 532, and at least part of the lower wall portion 554 can be positioned directly below the other one of the propellers 532.

The motor storage area 547b can be configured to allow the motor assembly 530 to be stored partially inboard relative to the outer surface 503 of the fuselage 502, or to be stored fully inboard relative to the outer surface 503 of the fuselage 502.

The motor storage area 547b may have a maximum internal height that is defined by a largest spacing between the upper wall portion 552 and the lower wall portion 554 inboard from the outer surface 503 of the fuselage 502. The maximum internal height of the motor storage area 547b is greater than the maximum internal height of the wing storage area 547a. In addition, a minimum internal height of the motor storage area 547b may be greater than or equal to the maximum internal height of the wing storage area 547a.

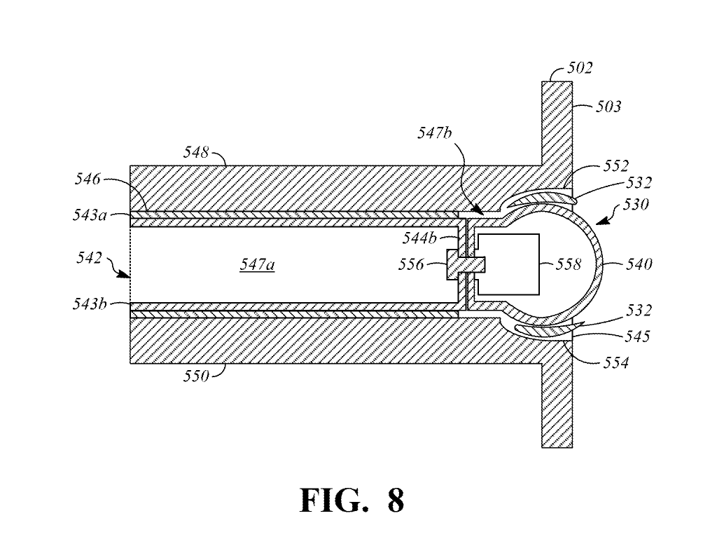

FIG. 9 is a cross-section view showing a wing 642. The wing 642 and other features shown in FIG. 9 are the same as features described with respect to FIGS. 7A-7D and FIG. 8 except as described herein.

The wing 642 one or more telescopically-related portions, such as an inner section 643a and an outer section 643b, which are shown in the retracted position. A motor assembly 630 is connected to an outer end 644b of the wing 642 by a pivot joint 656 and a pivot actuator 658.

In the retracted position, the wing 642 is located in a storage bay 646 that is formed in a fuselage 602 of the aircraft, which can be, as examples, the first aircraft 100, the second aircraft 200, or the third aircraft 300. The storage bay 646 has a wing storage area 647a defined in part by an upper structure 648 and a lower structure 650.

The storage bay 646 meets an outer surface 603 of the fuselage 602 at an opening 645 of the storage bay 646. A motor storage area 647b is located near the opening 645, and allows at least partial retraction of the motor assembly 630 into the fuselage 602 in order to protect the motor assembly 630 including the propellers 632. The motor storage area 647b is located inboard from the outer surface 603 of the fuselage 602, and is defined by an upper wall portion 652 and a lower wall portion 654.

To protect the motor assembly 630 and enclosure the part of the motor storage area 647b where the propellers 632 are located, one or more closure panels are connected to the fuselage 602 adjacent to the opening 645. The closure panels are moveable with respect to the fuselage 602 between an open position when the wing 642 is in the extended position to allow the wing 642 to extend out of the opening 645, and a closed position when the wing 642 is in the retracted position to protect the motor assembly 630.

In the illustrated example, an upper closure panel 660 and a lower closure panel 662 are connected to the fuselage 602. The upper closure panel 660 is connected to the fuselage 602 above the opening 645 and extends downward, approximately to a vertical midpoint of the opening 645. The lower closure panel 662 is connected to the fuselage 602 below the opening 645 and extends upward, approximately to a vertical midpoint of the opening 645.

The upper closure panel 660 and the lower closure panel 662 are connected to the fuselage 602 in a manner that allows the upper closure panel 660 and the lower closure panel 662 to be moved between open and closed positions. The open positions of the upper closure panel 660 and the lower closure panel 662 allow extension of the wing 642. The closed positions of the upper closure panel 660 and the lower closure panel 662 position the upper closure panel 660 and the lower closure panel 662 outward from the motor assembly 630 to extend across the opening 645 and to at least partially obstruct the opening 645. The upper closure panel 660 and the lower closure panel 662 can be pivotally connected to the fuselage 602, for example, by an upper hinge 663 that connects the upper closure panel 660 to the fuselage 602 and by a lower hinge 665 that connects the lower closure panel 662 to the fuselage. Other types of structures can be utilized to connect the upper closure panel 660 and the lower closure panel 662 to the fuselage 602 for movement between the open and closed positions.

The upper closure panel 660 and the lower closure panel 662 extend at least part of the longitudinal length of the opening 645, The upper closure panel 660 and the lower closure panel 662 can extend along the entire length of the opening 645, along the entire length of the motor housing 640 or along at least half of the length of the opening 645.

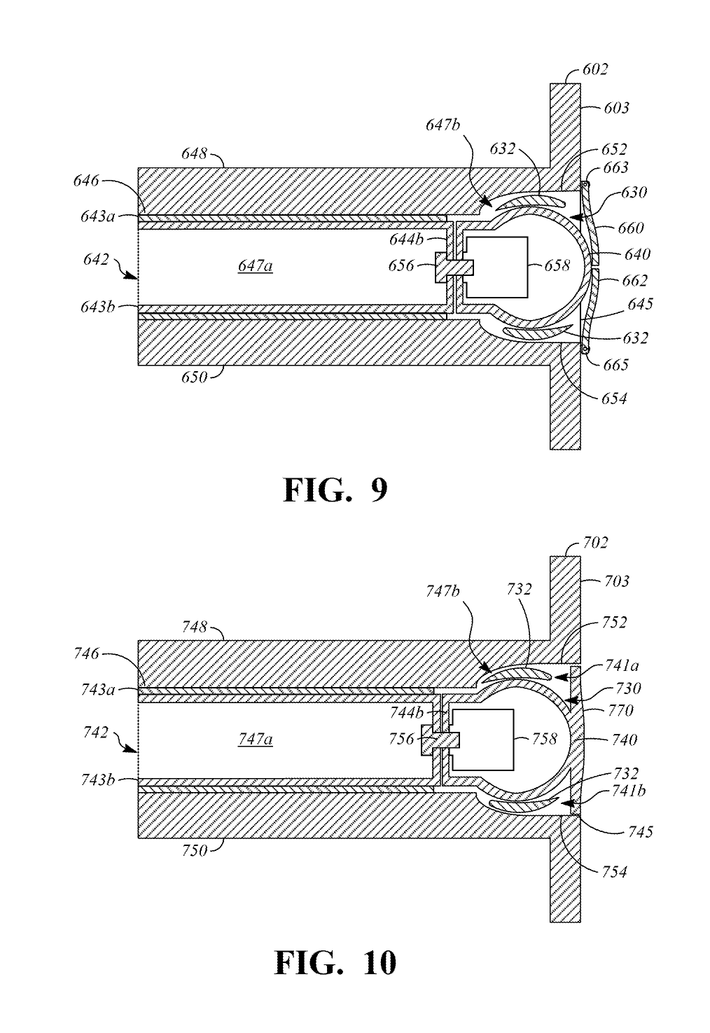

FIG. 10 is a cross-section view showing a wing 742. The wing 742 and other features shown in FIG. 10 are the same as features described with respect to FIGS. 7A-7D and FIG. 8 except as described herein.

The wing 742 one or more telescopically-related portions, such as an inner section 743a and an outer section 743b, which are shown in the retracted position. A motor assembly 730 is connected to an outer end 744b of the wing 742 by a pivot joint 756 and a pivot actuator 758.

In the retracted position, the wing 742 is located in a storage bay 746 that is formed in a fuselage 702 of the aircraft, which can be, as examples, the first aircraft 100, the second aircraft 200, or the third aircraft 300. The storage bay 746 has a wing storage area 747a defined in part by an upper structure 748 and a lower structure 750.

The storage bay 746 meets an outer surface 703 of the fuselage 702 at an opening 745 of the storage bay 746. A motor storage area 747b is located near the opening 745, and allows at least partial retraction of the motor assembly 730 into the fuselage 702 in order to protect the motor assembly 730 including the propellers 732. The motor storage area 747b is located inboard from the outer surface 703 of the fuselage 702, and is defined by an upper wall portion 752 and a lower wall portion 754.

To protect the motor assembly 730 and enclosure the part of the motor storage area 747b where the propellers 732 are located, a closure panel 770 is connected to the motor housing 740 of the motor assembly 730. The closure panel 770 can be connected to the motor housing 740 by rigid coupling structures such as fasteners or welds, or can be integrally formed as a portion of the motor housing 740 of the motor assembly 730. The closure panel 770 is located on an outside surface of the motor housing 740, opposite and outboard from the wing 742. The closure panel 770 can be connected to the motor housing 740 near a vertical midpoint of the motor housing 740, and extends upward and downward therefrom. The closure panel 770 can extend upward to a location near or past where the upper wall portion 752 of the motor storage area 747b meets the fuselage 702. The closure panel 770 can extend downward to a location near or past where the lower wall portion 754 of the motor storage area 747b meets the fuselage 702.

The closure panel 770 extends at least part of the longitudinal length of the opening 745, The closure panel 770 can extend along the entire length of the motor housing 740 or along at least half of the length of the opening 745.

The closure panel 770 cooperates geometrically with the motor housing 740 to define a first area in which one of the propellers 732 is stored above an upper surface 741a of the motor housing 740, and inboard from an inner surface 771a of the closure panel 770. The closure panel 770 cooperates geometrically with the motor housing 740 to define a second area in which the other one of the propellers 732 is stored below a lower surface 741b of the motor housing 740, and inboard from an inner surface 771a of the closure panel 770.

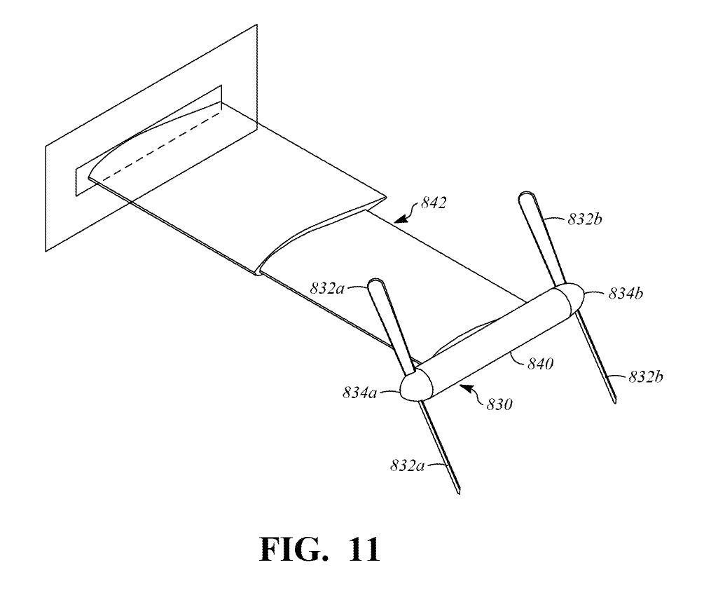

FIG. 11 is a perspective view of a motor assembly 830. The motor assembly 830 is similar to the motor assembly 430 and the descriptions in FIGS. 6A-6B and FIGS. 7A-7D, except as otherwise described herein. The motor assembly 830 can be pivotally mounted to a wing 842 for movement between horizontal flight and vertical flight configurations, as previously described. The motor assembly 830 includes a motor housing 840, a forward propeller hub 834a with forward propeller blades 832a connected to it, and a rearward propeller hub 834b with rearward propeller blades 832b connected to it. The forward propeller blades 832a and the rearward propeller blades 832b can be controller separately to provide thrust to the aircraft.

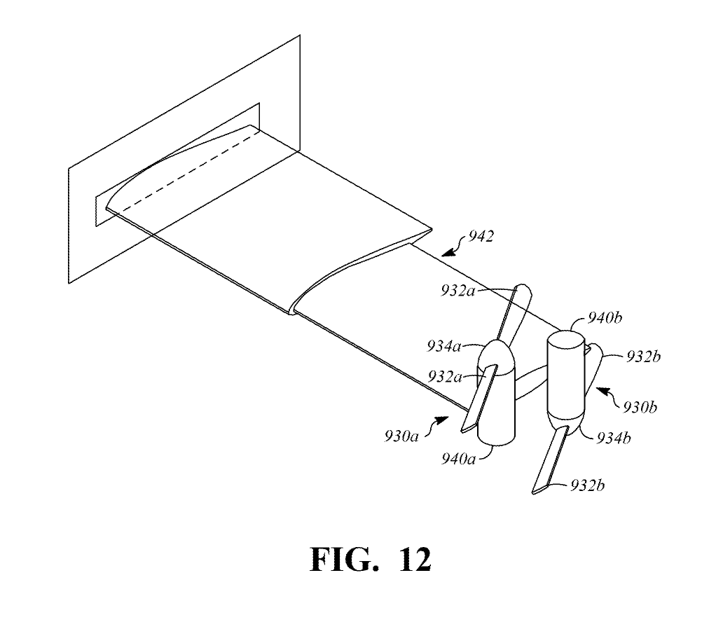

FIG. 12 is a perspective view of a first motor assembly 930a and a second motor assembly 930b. The first motor assembly 930a and the second motor assembly 930b, which are is similar to the motor assembly 430 and the descriptions in FIGS. 6A-6B and FIGS. 7A-7D, except as otherwise described herein. The first motor assembly 930a and the second motor assembly 930b can be pivotally mounted to a wing 942 for movement between horizontal flight and vertical flight configurations, as previously described. The first motor assembly 930a and the second motor assembly 930b are independently connected to the wing for and can pivot with respect to the wing independently. The first motor assembly 930a includes a motor housing 940a and a propeller hub 934a with propeller blades 932a connected to it. The second motor assembly 930b includes a second motor housing 940b and a propeller hub 934b with propeller blades 932b connected to it. The first motor assembly 930a and the second motor assembly 930b can be controller separately to provide thrust to the aircraft. The independent pivoting of the first motor assembly 930a and the second motor assembly 930b provides various thrust generating configurations for the aircraft

While the description relates to what are presently considered to be the most practical and preferred embodiments, it is to be understood various modifications or equivalent arrangements are included within the spirit and scope of the appended claims. The scope is to be accorded the broadest interpretation so as to encompass all such modifications and equivalent structures as is permitted under the law.

What is claimed is:

1. An aircraft, comprising:
a fuselage;
a storage bay formed in the fuselage;
a wing that has an outboard end, has an inboard end, is moveable relative to the fuselage in an outboard direction to an extended position, and is moveable relative to the fuselage in an inboard direction into the storage bay to a retracted position; and
a motor assembly that is located at the outboard end of the wing and is pivotally connected to the wing, wherein the motor assembly includes a propeller and a motor operable to rotate the propeller.

2. The aircraft of claim 1, wherein the storage bay includes a wing storage area and a motor storage area, and at least part of the motor is disposed in the motor storage areas of the storage bay when the wing is in the retracted position.

3. The aircraft of claim 2, wherein the propeller includes propeller blades and a propeller hub, wherein the propeller blades are pivotally connected to the propeller hub for movement between deployed positions and stowed positions.

4. The aircraft of claim 3, wherein the motor assembly includes a motor housing.

5. The aircraft of claim 4, wherein the propeller blades extend along the motor housing in the stowed position.

6. The aircraft of claim 5, wherein the motor storage area is defined in part by wall portions and the propeller blades are located between the motor housing of the motor assembly and the wall portions of the motor storage area when the propeller blades are in the stowed positions and the wing is in the retracted position.

7. The aircraft of claim 6, further comprising:
one or more closure panels are connected to the fuselage adjacent to an opening defined in the fuselage by the storage bay, wherein the closure panels are moveable with respect to the fuselage between an open position when the wing is in the extended position to allow the wing to extend out of the opening, and a closed position when the wing is in the retracted position to protect the motor assembly.

8. The aircraft of claim 7, wherein the one or more closure panels include an upper closure panel and a lower closure panel, wherein the upper closure panel is connected to the fuselage above the opening and extends downward, and the lower closure panel is connected to the fuselage below the opening and extends upward.

9. The aircraft of claim 6, wherein a closure panel is connected to the motor housing of the motor assembly and obstructs at least part of an opening defined in the fuselage by the storage bay when the wing is in the retracted position.

10. The aircraft of claim 9, wherein at least part of the closure panel extends upward from the motor housing to the fuselage when the wing is in the retracted position, and at least part of the closure panel extends downward from the motor housing to the fuselage when the wing is in the retracted position.

11. The aircraft of claim 9, wherein the propeller blades are located inboard relative to the closure panel when the wing is in the retracted position.

12. The aircraft of claim 1, wherein the motor assembly is pivotable with respect to the wing to a tractor position.

13. The aircraft of claim 1, wherein the motor assembly is pivotable with respect to the wing to a pusher position.

14. The aircraft of claim 1, wherein the motor assembly is pivotable with respect to the wing to a vertical flight position.

15. The aircraft of claim 1, further comprising:
a pivot joint that pivotally connects the motor assembly to the wing.

16. The aircraft of claim 15, further comprising:
a pivot actuator for pivoting the motor assembly with respect to the wing.

17. The aircraft of claim 1, wherein the wing has two or more telescopically-related sections.
